(19) United States
(12) Patent Application Publication
(10) Pub. No.: US 2024/0211720 A1
(43) Pub. Date: Jun. 27, 2024

(54) METHODS, SYSTEMS, APPARATUSES, AND COMPUTER-READABLE MEDIA FOR DECOMPOSING A LAYER IN A NEURAL NETWORK

(71) Applicant: HUAWEI TECHNOLOGIES CO., LTD., Shenzhen (CN)

(72) Inventors: Habib HAJIMOLAHOSEINI, Ottawa (CA); Walid AHMED, Ottawa (CA); Yang LIU, Ottawa (CA)

(21) Appl. No.: 18/087,877

(22) Filed: Dec. 23, 2022

(51) Int. Cl. G06N 3/04

(52) U.S. Cl. CPC G06N 3/04

(57) ABSTRACT

There is described a method for decomposing a layer in an artificial intelligence (AI) model. A rank of decomposition is calculated based on a performance function of a processor. The layer is decomposed into a plurality of matrices based on the rank of decomposition. The layer is replaced in the AI model with the plurality of matrices to produce a compressed AI model.

### FIELD OF THE DISCLOSURE

The present disclosure relates generally to methods, apparatuses, and computer-readable storage media for artificial intelligence (AI) models, and in particular to methods, apparatuses, and computer-readable storage media for decomposing a layer in an AI model.

### BACKGROUND

Trainable parameters of AI models may be represented by matrices for fully connected (FC) layers or tensors for convolutional (Conv) layers. Low Rank Decomposition (LRD) is a technique used for compressing the AI models by decomposing their weight matrices into a sequence of smaller ones. Singular Value Decomposition (SVD) and its higher order version such as Tucker decomposition are the most popular methods used for decomposing the matrices and tensors, respectively. Compressing the layers in the AI model may reduce the storage requirements for the AI model and increase the performance of the AI model. There is therefore a need for improved methods for compressing the layers of an AI model.

### SUMMARY

Generally, according to some embodiments of the disclosure, there are described methods for decomposing a layer in an artificial intelligence (AI) model. Trainable parameters of AI models, such as neural networks, may be represented by matrices for fully connected (FC) layers or tensors for convolutional layers. Low Rank Decomposition (LRD) is a technique used for compressing the AI models by decomposing their weight matrices into a sequence of smaller ones. Singular Value Decomposition (SVD) and its higher order version such as Tucker decomposition are the most popular methods used for decomposing the matrices and tensors, respectively. Each of these methods of decomposition require the selection of a rank of decomposition.

The way the rank r is chosen for each of the layers of an AI model is relevant, as the performance of the AI model depends on them. If r is too small, the model becomes very small (that is, with a high compression ratio) but the accuracy may drop significantly. If r is too large, accuracy may be preserved, but the decomposed model may not be small enough and so the desired compression ratio may not be achieved.

The following function may be used to find the optimal rank of decomposition:

$$f ( r ) = \frac{r}{t ( r )}$$

where t(r) represents the processing time or performance function of a decomposed layer with rank r. The following optimization method may be used:

$${R}_{opt} = {arg max}_{{R}_{min} \leq r \leq R} \frac{r}{t ( r )}$$

$$where {R}_{min} = \frac{m \times n}{( p + 1 ) \times ( m + n )} and R = \frac{m \times n}{p \times ( m + n )}$$

and p is the compression ratio. That is, calculating the rank of decomposition may comprise maximizing the function

$$f ( r ) = \frac{r}{t ( r )}$$

over a given range of r. Calculating the maximum point in the function ƒ(r) will find the optimum rank which minimizes the processing time t(r), while maximizing the rank r in the range specified in the optimization. The optimization may be performed over the range of ranks that achieve a compression ratio from p to p+1. This method of calculating a rank of decomposition takes into account the compression ratio, the accuracy, and the processing time of the decomposed layer.

According to a first aspect of the disclosure, there is described a method for decomposing a layer in an AI model, comprising: calculating a rank of decomposition based on a performance function of a processor; decomposing the layer into a plurality of matrices based on the rank of decomposition; and replacing the layer in the AI model with the plurality of matrices to produce a compressed AI model.

Decomposing the layer may comprise Singular Value Decomposition (SVD) or Tucker decomposition. SVD is a standard method of decomposition for fully connected layers. Tucker decomposition is a standard method of decomposition for convolutional layers.

The processor may be a server processor, a desktop processor, a virtual processor in a cloud, a mobile device processor, or the like. The performance function (r) may vary depending on the hardware, processor, device, and/or the like. The AI model may be trained or executed on a number of different devices. The rank of decomposition may be selected based on the target processor. The processor may be, for example, a Huawei Ascend 910 processor.

The performance function may measure floating-point operations per second, processing time, throughput of the specific processor, and/or the like. The performance function may measure different performance criteria of the processor. The performance function may also measure different performance criteria of the device. For example, the performance function may measure memory consumption on the device by the AI model.

The method may further comprise calculating the performance function. The method may comprise decomposing a sample layer using each rank of decomposition in the desired range, processing the decomposed layer on the target processor, and measuring a performance measure of the processor. Alternatively, the performance function may be inferred from known information about the implementation of the processor. Calculating the performance function may comprise decomposing the layer into a plurality of test matrices based on a test rank; computing a function based on the plurality of test matrices; and measuring a performance metric of the processor.

Decomposing the layer may comprise removing one or more rows or columns from the plurality of matrices, such that a number of rows or columns of at least one of the plurality of matrices equals the rank of decomposition.

The plurality of matrices may comprise two matrices or three matrices. The layer may be a matrix. The layer may be a tensor. A matrix is a two dimensional data structure. A tensor is a data structure with more than two dimensions. Fully connected layers may be represented by matrices, which may be decomposed into two matrices. Convolutional layers may be represented by tensors, which can be decomposed into three matrices.

Calculating the rank of decomposition may comprise maximizing a function

$$\frac{r}{t ( r )}$$

over a given range of r, wherein r is the rank of decomposition and t(r) is the performance function. The given range of r may be from

$$\frac{m \times n}{( p + 1 ) \times ( m + n )} to \frac{m \times n}{p \times ( m + n )} ,$$

wherein m is a number of rows of the matrix, n is a number of columns of the matrix, and p is a given compression ratio. Alternatively, the given range of r may be determined by Empirical Variational Bayesian Matrix Factorization.

Calculating the rank of decomposition may comprise maximizing a function

$$\frac{{r}_{1} \times {r}_{2}}{t ( {r}_{1} , {r}_{2} )} ,$$

wherein r₁ is a first rank, r₂ is a second rank, and t(r₁, r₂) is the performance function. This function may be used, for example, with convolutional layers comprising tensors, which may comprise more than one rank of decomposition.

Other functions may be used for calculating the rank of decomposition. Calculating the rank of decomposition may comprise maximizing a function log(r)−log(t(r)) over a given range of r, wherein r is the rank of decomposition and t(r) is the performance function. Calculating the rank of decomposition may comprise maximizing a function

$$\frac{\sqrt{r}}{t ( r )}$$

over a given range of r, wherein r is the rank of decomposition and t(r) is the performance function.

The AI model may be a neural network, and wherein the layer is a fully connected layer or a convolutional layer of the neural network.

According to a further aspect of the disclosure, there is provided a non-transitory computer-readable medium comprising computer program code stored thereon for decomposing a layer in an AI model, wherein the code, when executed by one or more processors, causes the one or more processors to perform a method comprising: calculating a rank of decomposition based on a performance function of a target processor; decomposing the layer into a plurality of matrices based on the rank of decomposition; and replacing the layer in the AI model with the plurality of matrices to produce a compressed AI model.

The method may furthermore comprise performing any of the operations described above in connection with the first aspect of the disclosure.

A further aspect of the disclosure comprises use of the compressed AI model to calculate an inference of the AI model or to train the AI model.

The method disclosed herein provides a number of advantages. Principally, the method takes into account accuracy, compression, and performance. The method may achieve a compression ratio within a desired range. Further, the accuracy of the compression may be optimized. Further, the performance of the compression may be optimized. Moreover, compression may be optimized for a specific processor.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

For a more complete understanding of the disclosure, reference is made to the following description and accompanying drawings, in which:

FIG. 1 is a schematic diagram of a computer network system for decomposing a layer in an AI model, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a flow diagram of a method performed by the computer network system shown in FIG. 1 for decomposing a layer in an AI model, according to some embodiments of this disclosure;

FIG. 5 is a graph showing the performance of a decomposed layer of an AI model decomposed by the method shown in FIG. 4, according to some embodiments of this disclosure;

FIG. 6 is a graph showing the performance of a decomposed layer of an AI model decomposed by the method shown in FIG. 4, according to some embodiments of this disclosure;

FIG. 7 is a schematic diagram of a layer in an AI model used by the computer network system shown in FIG. 1, according to some embodiments of this disclosure;

FIG. 8 is a schematic diagram of a method performed by the computer network system shown in FIG. 1 for decomposing a layer in an AI model, according to some embodiments of this disclosure;

FIG. 9 is a schematic diagram of an AI model used by the computer network system shown in FIG. 1, according to some embodiments of this disclosure;

FIG. 10 is a schematic diagram of a compressed AI model used by the computer network system shown in FIG. 1, according to some embodiments of this disclosure; and

FIG. 11 is a schematic diagram of a decomposed layer in a convolutional neural network used by the computer network system shown in FIG. 1, according to some embodiments of this disclosure.

### DETAILED DESCRIPTION

Embodiments disclosed herein relate to a compression module or circuitry for executing a compression process.

As will be described later in more detail, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

As will be described in more detail below, the compression module may be a part of a device, an apparatus, a system, and/or the like, wherein the compression module may be coupled to or integrated with other parts of the device, apparatus, or system such that the combination thereof forms the device, apparatus, or system. Alternatively, the compression module may be implemented as a standalone encryption/decryption device or apparatus.

The compression module executes a compression process for decomposing a layer in an AI model. Herein, a process has a general meaning equivalent to that of a method, and does not necessarily correspond to the concept of computing process (which is the instance of a computer program being executed). More specifically, a process herein is a defined method implemented using hardware components for processing data (for example, matrices, tensors, and/or the like). A process may comprise or use one or more functions for processing data as designed. Herein, a function is a defined sub-process or sub-method for computing, calculating, or otherwise processing input data in a defined manner and generating or otherwise producing output data.

As those skilled in the art will appreciate, the compression process disclosed herein may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. The compression module may read the computer-executable code from the storage devices and execute the computer-executable code to perform the encryption and/or decryption processes.

Alternatively, the compression process disclosed herein may be implemented as one or more hardware structures having necessary electrical and/or optical components, circuits, logic gates, integrated circuit (IC) chips, and/or the like.

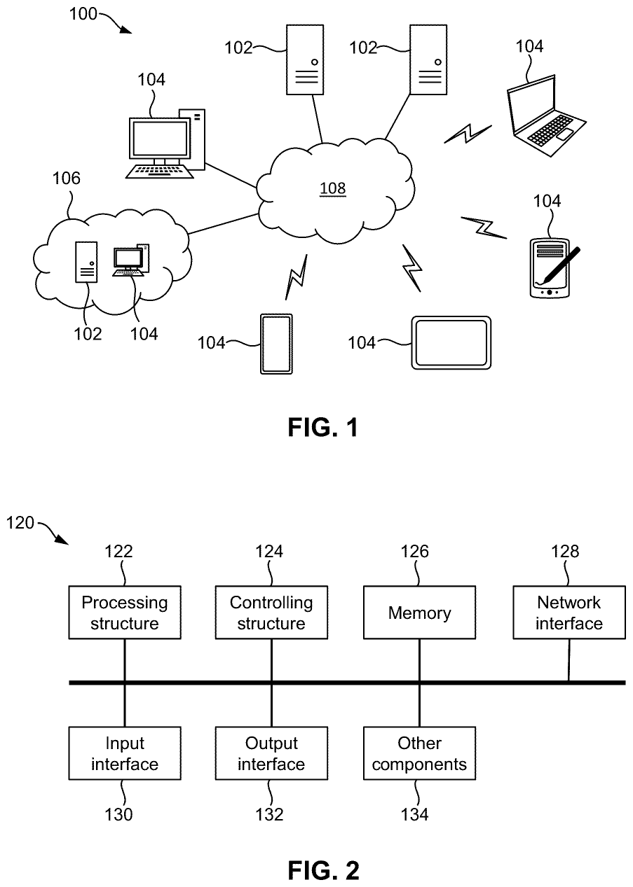

Turning now to FIG. 1, a computer network system for decomposing a layer in an AI model is shown and is generally identified using reference numeral 100. In these embodiments, the AI system 100 is configured for decomposing a layer in an AI model.

As shown in FIG. 1, the AI system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure 120 shown in FIG. 2. As shown, the hardware structure 120 comprises a processing structure 122, a controlling structure 124, one or more non-transitory computer-readable memory or storage devices 126, a network interface 128, an input interface 130, and an output interface 132, functionally interconnected by a system bus. The hardware structure 120 may also comprise other components 134 coupled to the system bus.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARMR microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing an encryption process and/or a decryption process, as the design purpose and/or the use case maybe, for encrypting and/or decrypting data received from the input 106 and outputting the resulting encrypted or decrypted data through the output 108.

For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processings thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 1, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FIR (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

A system bus may interconnect various components 122 to 134 enabling them to transmit and receive data and control signals to and from each other.

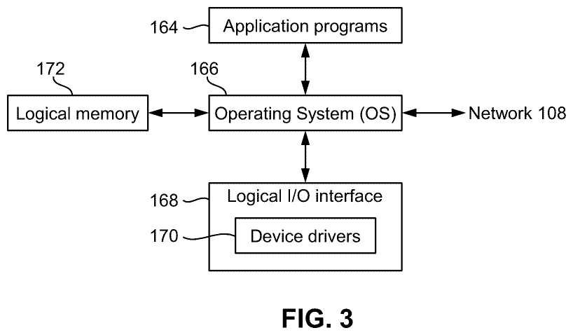

FIG. 3 shows a simplified software architecture 160 of the computing device 102 or 104. The software architecture 160 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® IOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 of the AI system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the AI system 100 may have the potential to perform various tasks, it cannot perform any tasks and is of no use without meaningful firmware and/or software. As will be described in more detail later, the AI system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

Trainable parameters of AI models, such as neural networks, may be represented by matrices for fully connected (FC) layers or tensors for convolutional layers. Low Rank Decomposition (LRD) is a technique used for compressing the AI models by decomposing their weight matrices into a sequence of smaller ones. Singular Value Decomposition (SVD) and its higher order version such as Tucker decomposition are the most popular methods used for decomposing the matrices and tensors, respectively. SVD is a technique used for decomposing a matrix into a series of new matrices so that if they are multiplied together, the original matrix is reconstructed. If the matrix is not full rank, it means that there is some redundancy in it. Therefore, some of the rows or columns of the SVD-decomposed matrices can be truncated and the truncated matrices can be multiplied together to reconstruct the original matrix with minimal information loss. In this way, some memory and computational time can be saved. This process is known as LRD.

Consider a matrix A with m rows and n columns, which may represent a layer in an AI model. A has m×n parameters. If m and n are large numbers, matrix A would have a large number of trainable parameters. This matrix A may be decomposed into two matrices U and V using the SVD method (subscripted numbers show the number of parameters in each matrix):

$${A}_{m \times n} = {U}_{m \times m} {S}_{m \times n} {V}_{n \times n}^{T} = {\sum }_{i = 1}^{min \{ m , n \}} {s}_{i} {u}_{i} {v}_{i}^{T}$$

Note that S is a diagonal matrix containing only the scaling factors for the other two matrices and therefore does not represent any decomposed layer. However, in the above summation, if only the first r terms are chosen (where r<min(m,n)), the new matrix Ã_{m×n} may be a lower rank approximation (denoted Ã_{m×n}) of A_{m×n} with rank of r:

$${\tilde{A}}_{m \times n} = {U}_{m \times r} {S}_{r \times r} {V}_{r \times n}^{T} = {\sum }_{i = 1}^{r} {s}_{i} {u}_{i} {v}_{i}^{T}$$

The way the rank r is selected for each of the layers of an AI model is relevant, as the performance of the AI model depends on them. If r is too small, the model becomes very small (that is, having a high compression ratio) but the accuracy may drop significantly. If r is too large, the accuracy may be preserved, but the decomposed model may not be small enough and so the desired compression ratio may not be achieved. Note that the maximum possible value for the rank is min(m, n).

The rank of a matrix is the number of linearly independent rows or columns of the matrix. A matrix is called full rank when all of its rows or columns are linearly independent. So the rank of a matrix is equal to or less than the minimum of the number of rows and columns.

One known method for selecting the rank of decomposition is to choose a fixed rank for all the layers in the model. This method is known as Manual Rank Selection. Let A be a matrix with m rows and n columns. Matrix A therefore has m×n parameters. The matrix may be decomposed using the SVD method into two matrices with dimensions m×r and r×n, such that the total number of parameters in the decomposed layer may be (m×r)+(r×n). The compression ratio p may be calculated as:

$$p = \frac{m \times n}{( m \times r ) + ( r \times n )} = \frac{m \times n}{r \times ( m + n )}$$

With Manual Rank Selection, all of the layers may have the same rank and different compression ratios, depending on their dimensions.

Another known method for calculating the rank of decomposition is to calculate a rank for each layer so that a desired compression ratio is achieved for each layer. This method is known as Constant Compression Rate (CCR). Given a desired compression factor p, the rank for each layer may be calculated as:

$$r = \frac{m \times n}{p \times ( m + n )}$$

With Constant Compression Rate, all the layers of the model may have the same compression ratio, and each layer may have a different rank calculated based on the specific dimensions of the layer.

Another known method for calculating the rank of decomposition is to use a Bayesian approach in order to minimize the data redundancy in the layer. An extreme rank may first be calculated using the global analysis solution such as Empirical Variational Bayesian Matrix Factorization (EVBMF). All of the redundancy may be removed from the layer using the EVBMF rank. In order to have a safety margin, a weakening factor may be used (0≤α≤1) in order to preserve some of the redundancy, which improves accuracy. The rank may be calculated as follows:

$$r = min ( m , n ) - α ( min ( m , n ) - {r}_{EVBMF} )$$

where r_{EVBMF} is the extreme rank calculated by EVBMF. In this equation, by changing factor α between 0 and 1, the rank changes between its maximum possible which is min(m,n) and the extreme rank calculated by EVBMF (r_{EVBMF}).

There are disadvantages with each of these known methods. With Manual Rank Selection, the compression ratio cannot be controlled. Manual Rank Selection also does not take into account the accuracy loss after decomposition. With the CCR method, the compression ratio may be controlled, but it does not consider the accuracy drop after the decomposition as this method only uses tensor dimensions to calculate the rank so that the desired compression ratio is satisfied. With the EVBMF method, the accuracy loss may be controlled in terms of the redundancy removal from the matrices and hence the accuracy of the decomposed model may be preserved close to that of the original. However, the compression ratio cannot be controlled.

In addition to these shortcomings, another disadvantage all of these rank estimation techniques have in common is that the acceleration of the decomposed models is not proportional to the compression ratio. The throughput of the decomposed layers is not considered for rank estimation. In other words, after applying LRD, the computational complexity (in terms of number of floating-point operations per second (FLOPs)) and memory consumption should drop proportionally to the compression ratio. However, it is surprisingly found that training/inference speed-up may not be proportional to FLOPs or compression ratio.

The following table compares the well-known architecture ResNet-101 before and after applying the LRD with a compression ratio of two (2) (meaning that the model will be compressed by 2). By applying 2× compression to the model, the FLOPs decrease proportionally but the throughput does not improve significantly on GPU (less than 10%). It even gets worse on NPU, being slower than the original model.

| | Comp | | Δ Throughput (fps) | Δ Throughput (fps) |
|---|---|---|---|---|
| Model | Ratio | Δ FLOPs | on GPU | on NPU |
| ResNet- | 0 | 0% | 0% | 0% |
| 101 | | | | |
| LRD | 2x | −46.53% | +9.66% | −17.53% |

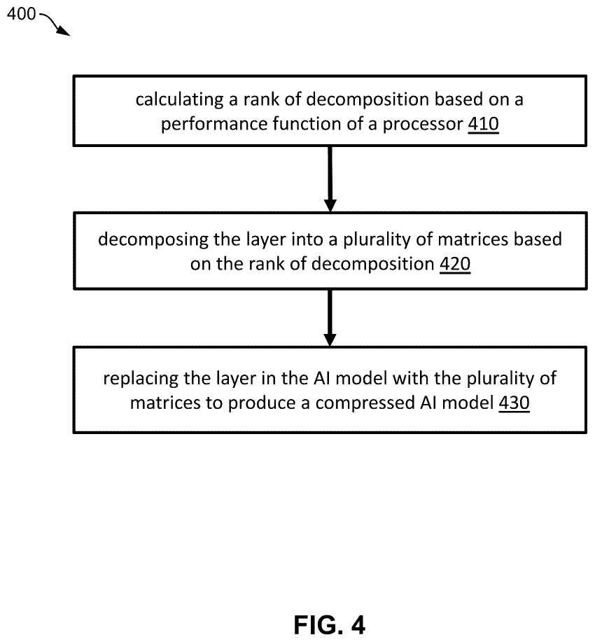

Reference is now made to FIG. 4, which shows a method 400 for decomposing a layer in an artificial intelligence (AI) model. The method 400 comprises calculating a rank of decomposition based on a performance function of a processor 410. In contrast with the known rank selection methods, which take into account either compression ratio or accuracy but not the processing time, the method 400 considers accuracy, compression ratio, and processing time or throughput.

According to the LRD equation, the higher the rank r, the lower the reconstruction error and therefore the higher the accuracy, as more terms of the summation are used:

$${Ã}_{m \times n} = {U}_{m \times r} {S}_{r \times r} {V}_{r \times n}^{T} = {\sum }_{i = 1}^{r} {s}_{i} {u}_{i} {v}_{i}^{T}$$

In order to guarantee that the desired compression ratio of p will be achieved, a rank that is smaller or equal to the rank calculated by the CCR method may be used:

$$p \leq \frac{m \times n}{r \times ( m + n )} ⇒ r \leq \frac{m \times n}{p \times ( m + n )}$$

The rank may also be selected to minimize the processing time of the decomposed layers. The function (r) may represent the processing time of the layer decomposed with rank r. To generate t(r), the processing time may be calculated for each rank in a given range, such as the range from

$$\frac{m \times n}{( p + 1 ) \times ( m + n )} to \frac{m \times n}{p \times ( m + n )} .$$

The processing time may be calculated for any given range of ranks. To calculate the processing time, a sample matrix or tensor containing random data with the same dimensions as the corresponding layer in the AI model may be used to calculate the time required for the layer to generate the output. Calculating the processing time may comprise determining the time it takes for the processing structure 122 to multiply the sample matrix or tensor representing a weight matrix by a vector or matrix representing a feature vector or matrix. The function t(r) may be defined in any other manner possible. For example, it may be possible to represent the processing time of a range of ranks on a given processing structure 122 using a mathematical function. It may be possible to infer the function t(r) from information about the processing structure 122 or from tests run on the processing structure 122. The manufacturer of the processing structure 122 may provide t(r).

The function t(r) may be used to calculate the rank that minimizes the processing time. It is generally believed that the smaller the rank, the lower the processing time. However, it has been surprisingly discovered through experiments that this is not the case. Moreover, the low-level implementations of computational operations may vary across processors. As such, each processor may have a different rank that minimizes the processing time. The following function may be used to find the optimal rank of decomposition for a given processor:

$$f ( r ) = \frac{r}{t ( r )}$$

The following optimization method may be used:

$${R}_{opt} = {arg max}_{{R}_{min} \leq r \leq R} \frac{r}{t ( r )}$$

$$where {R}_{min} = \frac{m \times n}{( p + 1 ) \times ( m + n )} and R = \frac{m \times n}{p \times ( m + n )} .$$

That is, calculating the rank of decomposition may comprise maximizing the function

$$f ( r ) = \frac{r}{t ( r )}$$

over a given range of r. Other functions and optimization methods may be used to find the rank with the optimal processing time. Calculating the maximum point in the function ƒ(r) may find the optimum rank which minimizes the processing time t(r), while maximizing the rank r in the range specified in the optimization. The optimization may be performed over the range of ranks that achieve a compression ratio from p to p+1. The optimization may be performed over any range of ranks. The processing time of the decomposed layer may be compared with that of the original layer. If the processing time of the decomposed layer is slower than the original layer, the original layer may be used rather than the decomposed layer.

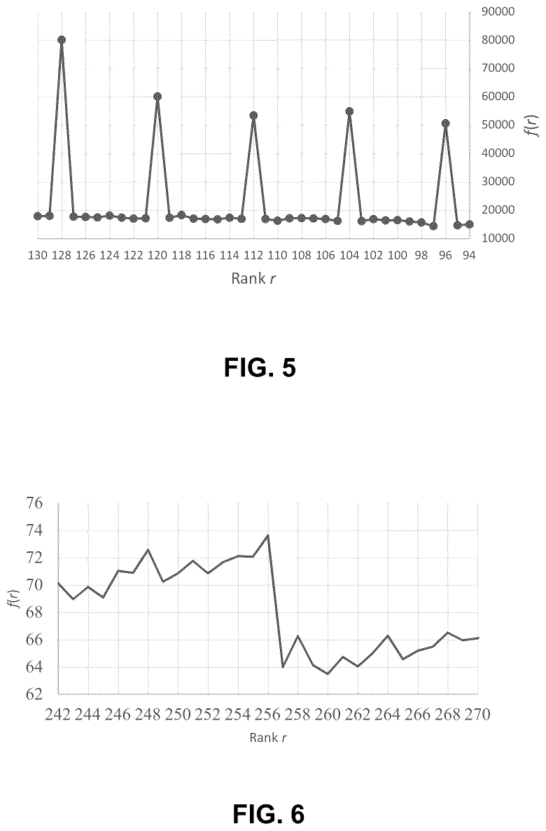

Reference is now made to FIG. 5, which shows a graph of the function ƒ(r) versus r for an FC layer of a model being processed by a Huawei Ascend 910 processor. As shown in FIG. 5, the optimum rank of decomposition is 128. Moreover, the processing time does not improve proportionally as the rank decreases, as is commonly believed. Selecting the lowest rank does not result in the greatest speed-up/accuracy trade-off.

Reference is now made to FIG. 6, which shows a graph of the function ƒ(r) versus r for a Conv layer of a model being processed by a V100 GPU processor instead of the Huawei Ascend 910. In this case, the optimum rank of decomposition is 256. Once again, the optimum rank that results in the greatest speed-up/accuracy trade-off is not associated with the lowest rank. Since the shape of the graph in FIG. 6 is different from the shape of the graph in FIG. 5, the function ƒ(r) depends on the low-level implementation of the operations on different hardware. The processing time for a given rank may be different on different devices, and the optimum rank for a given layer may be different on different devices. Decomposition of layers in an AI model may be tailored to specific devices in order to optimize performance.

In contrast with the prior art, which only considers the compression ratio or accuracy after decomposition for rank selection, the method 400 may consider accuracy, compression ratio, and the acceleration after decomposition. Specifically, the accuracy may be maximized in function ƒ(r) by maximizing the rank r and the processing time may be optimized by minimizing the function t(r). The compression ratio may also be guaranteed in the conditional optimization problem by selecting a rank as

$$r \leq \frac{m \times n}{p \times ( m + n )} .$$

That is, the function ƒ(r) may be optimized over a range of ranks that guarantee a specific compression ratio.

In contrast with the prior art which calculates the rank independently of the hardware being used, the method 400 may calculate a different performance function (r) for difference devices or processors. This function t(r) may have different shapes on different devices depending on their low-level implementation of the operations. Therefore, the method 400 may generate different ranks on different processors depending on their hardware architecture.

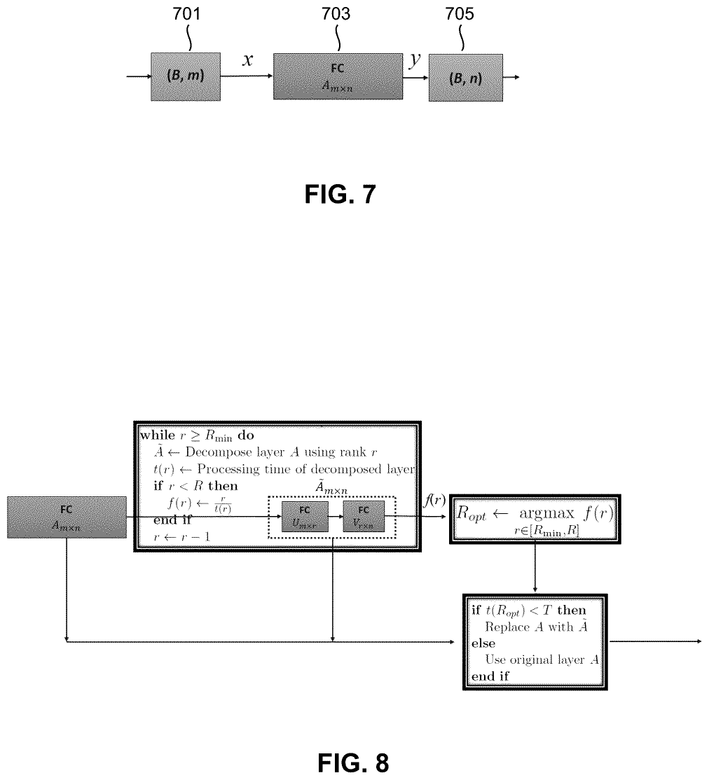

The method 400 further comprises decomposing the layer into a plurality of matrices based on the rank of decomposition 420. The calculated optimum rank may be used in any LRD-based compression method in which the LRD is applied to decompose the FC or Conv layers of an AI model. Reference is now made to FIG. 7, which shows a layer 703 in an AI model. The layer 703 may receive a batch of input vectors 701 of size m and transform them into a batch of output vectors 705 of size n. The layer 703 may be an m×n matrix. By applying SVD with the optimum rank r calculated in step 410, the FC layer 703 may be decomposed into two layers or matrices. The method is shown in FIG. 8. Methods such as SVD and Tucker decomposition may be used to decompose the layer 703 using the optimum rank r calculated in step 410. The decomposition may result in two or more matrices.

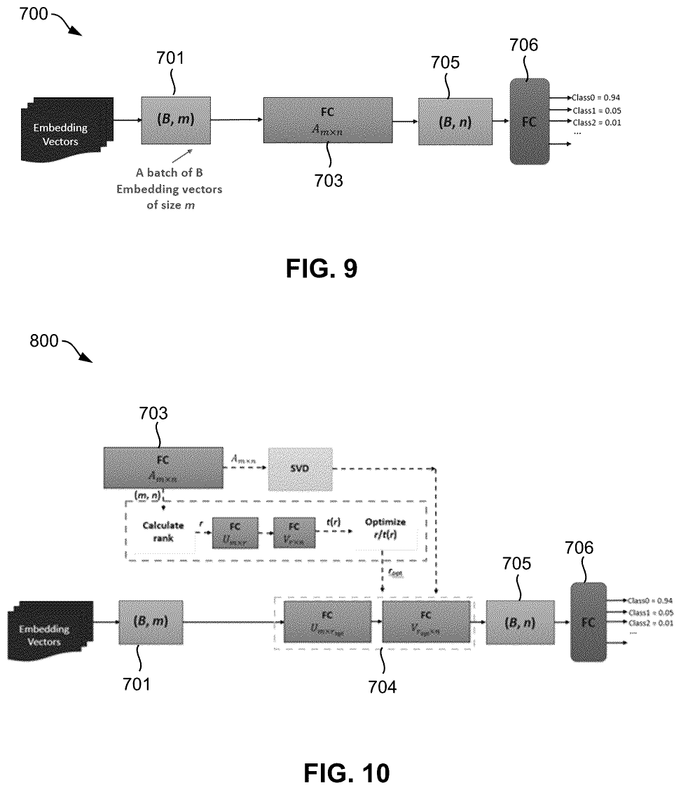

The method 400 further comprises replacing the layer 703 in the AI model with the plurality of matrices to produce a compressed AI model 430. Reference is now made to FIG. 9, which shows an AI model 700. The AI model 700 may be a classification model. The AI model may comprise an FC layer 703. The FC layer 703 may receive batch of input vectors 701 of size m and transform them into a batch of output vectors 705 of size n. The layer 706 may then map the output vectors 705 into one of a series of classes by calculating a probability that each vector is in one of those classes. The FC layer 703 may comprise a weight matrix of A_{m×n} that may process the input vectors 701 and convert them into a batch of output vectors 705 of size n.

Reference is made to FIG. 10 which shows a compressed AI model 800. The original layer 703 may be decomposed into two or more smaller layers 704 using the SVD method with the optimum rank calculated in step 410. Any other method of decomposition, such as Tucker decomposition, may be used as well. The layer 703 in the AI model 700 may then be replaced with the smaller layers 704 to produce the compressed AI model 800. The smaller layers 704 may be matrices. There may be two or more smaller layers 704. Since the layers 704 are smaller than the original layer 703, the AI model 800 may have a smaller memory footprint than the original AI model 700. Since the processing time is taken into account, the processing time of the compressed AI model 800 may be shorter than, or at least not longer than, the processing time of the original AI model 700.

The processor 122 may be a server processor, a desktop processor, a virtual processor in a cloud, a mobile device processor, or the like. The processor 122 may be the targeted processor on which the AI model 800 will perform inference or training. The AI model 800 may be intended for use on different types of devices, such as server computers, desktop computers, tablets, mobile devices, virtual computers in the cloud, and/or the like. The AI model 800 may be trained on a different device from the device on which it will perform inference. For example, if the AI model 800 is intended for use on a mobile device, improvements in compression and processing time may be more important. The processor 122 may be a Huawei Ascend 910 processor or a V100 GPU. The processor 122 may be a general purpose CPU. Alternatively, the processor 122 may be a GPU or NPU.

The performance function (r) may measure floating-point operations per second, processing time, or throughput of the target processor 122. Any other measure of performance of the processor 122 may be used instead. The performance function may measure the performance when the processor 122 is processing the layer 703 or the compressed layer 704 in the AI model 700 or 800.

The method 400 may further comprise calculating the performance function (r). Calculating the performance function may comprise measuring the performance of the processor 122 experimentally. For example, calculating the performance function may comprise decomposing the layer 703 into a plurality of test matrices based on a test rank. The test rank may be one of a series of ranks in a range for which the performance needs to be measured, so that this method may be repeated for each rank in the range. The test matrices may be matrices with the same dimensions as the actual layers in the AI models but with random weights and input tensors, such that the time to generate the output of the test matrices may be the same as the time to generate the output of the actual matrices.

The method 400 may further comprise computing a function based on the plurality of test matrices, and measuring a performance metric of the processor 122. Computing a function based on the plurality of test matrices may comprise multiplying the test matrices by an input tensor of features. Measuring the performance function may comprise measuring the time that the processor 122 takes to perform the mathematical function of multiplying the test matrices by an input tensor of features. The actual matrices from the AI model may not be used. Substitute test matrices may be used to determine the performance of the processor 122 when processing the decomposed layers 704. Alternatively, the actual matrices from the AI model may be used to generate the performance function. As another alternative, the performance function (r) may be estimated based on information about the target processor 122, such as how it implements low-level mathematical operations. It may be possible to run a simple experiment on the processor 122 for performing a simple mathematical operation and then infer from that experiment to the performance function for processing matrices of different sizes. As another alternative, the performance function may measure some other performance measure of the device, such as memory consumption or energy consumption.

Decomposing the layer 703 may comprise removing one or more rows or columns from the plurality of matrices 704, such that a number of rows or columns of at least one of the plurality of matrices 704 equals the rank of decomposition. The layer 703 may comprise a matrix A with m rows and n columns. The layer 703 may be decomposed into two matrices U and V, where U has m rows and r columns and V has r rows and n columns, and where r is the optimal rank calculated in step 410. Since r may be less than m and n, U may have fewer columns than A, and V may have fewer rows than A. The extra columns in U and the extra rows in V may be removed in order to compress the layer 704.

FIG. 10 shows that layer 703 may be decomposed into two matrices 704. However, layer 703 may be decomposed into three matrices, or more than three matrices.

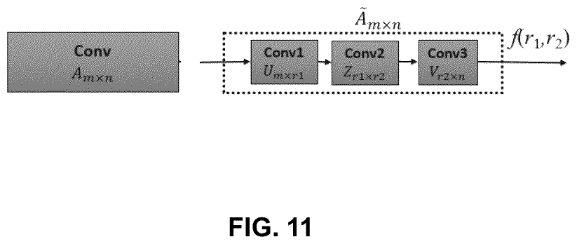

The layer 703 may be a matrix. The layer 703 may also be a tensor. Reference is made to FIG. 11, which shows a convolutional layer. The method 400 may be used with convolutional neural networks. In this case, the layers may comprise convolutional layers rather than FC layers. The convolutional layers may be decomposed into three layers using Tucker decomposition, or any other appropriate method of decomposition. Tucker decomposition takes two ranks r₁ and r₂. The optimization function may be defined as follows:

$$f ( {r}_{1} , {r}_{2} ) = \frac{{r}_{1} {r}_{2}}{t ( {r}_{1} , {r}_{2} )}$$

The optimization problem may be defined as follows:

$${R}_{opt} = {arg max}_{{R}_{min} \leq r \leq R} \frac{{ar}^{2}}{t ( {r}_{1} , {r}_{2} )}$$

wherein r₁=r and r₂=αr.

In another embodiment, the range of r over which the function ƒ(r) is optimized may be determined by Empirical Variational Bayesian Matrix Factorization (EVBMF). EVBMF determines r as follows:

$$r = min ( m , n ) - α ( min ( m , n ) - {r}_{EVBMF} )$$

where 0≤α≤1. The function ƒ(r) may be optimized over the range defined by α being in the range from 0 to 1. Alternatively, any other range may be used for optimization starting from the r calculated using EVBMF.

In another embodiment, calculating the rank of decomposition may comprise maximizing the function ƒ(r)=log(r)− log(t(r)) over a given range of r. In another embodiment, calculating the rank of decomposition may comprise maximizing the function

$$f ( r ) = \frac{√ r}{t ( r )}$$

over a given range of r. Such a function may be useful if accuracy is more important in a certain AI model.

The AI model 700 may be a neural network, and the layer 703 may be a fully connected layer or a convolutional layer of the neural network.

The compressed AI model 800 may be used to calculate an inference of the AI model or to train the AI model on the processor 122.

Although embodiments have been described above with reference to the accompanying drawings, those of skill in the art will appreciate that variations and modifications may be made without departing from the scope thereof as defined by the appended claims.

What is claimed is:

1. A method for decomposing a layer in an artificial intelligence (AI) model, comprising:
calculating a rank of decomposition based on a performance function of a processor;
decomposing the layer into a plurality of matrices based on the rank of decomposition; and
replacing the layer in the AI model with the plurality of matrices to produce a compressed AI model.

2. The method of claim 1, wherein decomposing the layer comprises decomposing the layer using Singular Value Decomposition or Tucker decomposition.

3. The method of claim 1, wherein the performance function measures floating-point operations per second, processing time, or throughput of the specific processor.

4. The method of claim 1, further comprising calculating the performance function.

5. The method of claim 4, wherein calculating the performance function comprises:
decomposing the layer into a plurality of test matrices based on a test rank;
computing a function based on the plurality of test matrices; and
measuring a performance metric of the processor.

6. The method of claim 1, wherein decomposing the layer comprises removing one or more rows or columns from the plurality of matrices, such that a number of rows or columns of at least one of the plurality of matrices equals the rank of decomposition.

7. The method of claim 1, wherein the plurality of matrices comprises two matrices or three matrices.

8. The method of claim 1, wherein the layer is a matrix.

9. The method of claim 1, wherein the layer is a tensor.

10. The method of claim 8, wherein calculating the rank of decomposition comprises maximizing a function
$$\frac{r}{t ( r )}$$
over a given range of r, wherein r is the rank of decomposition and t(r) is the performance function.

11. The method of claim 10, wherein the given range of r is from
$$\frac{m \times n}{( p + 1 ) \times ( m + n )} to \frac{m \times n}{p \times ( m + n )} ,$$
wherein m is a number of rows of the matrix, n is a number of columns of the matrix, and p is a given compression ratio.

12. The method of claim 10, wherein the given range of r is determined by Empirical Variational Bayesian Matrix Factorization.

13. The method of claim 9, wherein calculating the rank of decomposition comprises maximizing a function
$$\frac{{r}_{1} \times {r}_{2}}{t ( {r}_{1} , {r}_{2} )} ,$$
wherein r₁ is a first rank, r₂ is a second rank, and t(r₁, r₂) is the performance function.

14. The method of claim 8, wherein calculating the rank of decomposition comprises maximizing a function log(r)− log(t(r)) over a given range of r, wherein r is the rank of decomposition and t(r) is the performance function.

15. The method of claim 8, wherein calculating the rank of decomposition comprises maximizing a function
$$\frac{\sqrt{r}}{t ( r )}$$
over a given range of r, wherein r is the rank of decomposition and t(r) is the performance function.

16. The method of claim 1, wherein the AI model is a neural network, and wherein the layer is a fully connected layer or a convolutional layer of the neural network.

17. A non-transitory computer-readable medium comprising computer program code stored thereon for decomposing a layer in an AI model, wherein the code, when executed by one or more processors, causes the one or more processors to perform a method comprising:
calculating a rank of decomposition based on a performance function of a target processor;
decomposing the layer into a plurality of matrices based on the rank of decomposition; and
replacing the layer in the AI model with the plurality of matrices to produce a compressed AI model.

18. The non-transitory computer-readable medium of claim 17, wherein decomposing the layer comprises decomposing the layer using Singular Value Decomposition or Tucker decomposition.

19. The non-transitory computer-readable medium of claim 17, wherein the performance function measures floating-point operations per second, processing time, or throughput of the target processor.

20. Use of the compressed AI model of claim 1 to calculate an inference of the AI model or to train the AI model.
